(19) United States
(12) Patent Application Publication
(10) Pub. No.: US 2002/0130248 A1
(43) Pub. Date: Sep. 19, 2002

(54) Circuit arrangement and method of protecting at least a chip arrangement from manipulation and/or abuse

(76) Inventors: Ernst Bretschneider, Erfurt (DE); Johann Fuhrmann, Hildesheim (DE); Walter Einfeldt, Uetersen (DE)

Correspondence Address: U.S. Philips Corporation, 580 White Plains Road, Tarrytown, NY, 10591, US

(21) Appl. No.: 10/056,373

(22) Filed: Jan. 17, 2002

(30) Foreign Application Priority Data
Jan. 18, 2001 (DE) 10101995.5

(51) Int. Cl. H01J 40/14

(52) U.S. Cl. 250/214 R

(57) ABSTRACT

To provide an electric or electronic circuit arrangement (100) and a method of protecting at least a chip arrangement (200), for example, at least a (semiconductor) chip arrangement, particularly at least a controller chip arrangement for a chip card or smart card from manipulation and/or abuse, in which an optical attack by means of light irradiation on a controller chip arrangement itself and on a dielectric coating, particularly an insulating layer and/or passivation layer and/or further protective coating covering the controller chip arrangement for protecting the integrated circuit from external influences, both on the front side of the controller chip arrangement and on the substantially unprotected rear side of the controller chip arrangement can be reliably and permanently averted,

at least one, particularly optosensitive detector unit (10), whose output voltage (Vₒᵤₜ) is a measure of the incidence of light (Li) on the detector unit (10), and

at least one comparator unit (20) preceded by the detector unit (10) provided for comparing the output voltage (Vₒᵤₜ) of the detector unit (10) with a reference voltage (V_{ref}), wherein the data and/or functions of the chip arrangement (200) to be protected can be temporarily or permanently obstructed and/or erased (L) and/or blocked (S) and/or interrupted in the case of a failure message occurring during comparison of the output voltage (Vₒᵤₜ) of the detector unit (10) with the reference voltage (V_{ref}) are provided.

The invention relates to an electric or electronic circuit arrangement, and to a method of protecting at least a chip arrangement, for example, at least a (semiconductor) chip arrangement, particularly at least a controller chip arrangement for a chip card or smart card, from manipulation and/or abuse.

In connection with the protection from manipulation and/or abuse, the general trend is that the security requirements, particularly in the field of the smart card chip technique, become more stringent with an increasing use of smart cards such as, for example, bank cards, sickfund cards or various security chip cards. All of these chip cards have in common that sensitive data are stored which should be solely and exclusively accessible to the authorized user of the chip card within the scope defined hereinbefore. In this connection, it is usually the aim of unauthorized persons to read information from the chip card, particularly the controller chip arrangement, or analyze the functional components of the chip so as to use the chip card for manipulative and/or abusive purposes.

The controller chip arrangements currently on the market and future arrangements have in common that security-relevant data and/or functions are stored on them, which should absolutely be protected from abuse by unauthorized third persons. A manipulative possibility of obtaining unauthorized information about the structure, the data and/or the functions of a controller chip arrangement is offered by the irradiation of the controller chip arrangement with electromagnetic waves, particularly with light. This potential attack scenario is usually aimed at bringing the controller chip arrangement to a state in which a more or less simple access to security-relevant data and/or functions is possible. In this way, software-defined barriers may be at least partly overcome without authorization.

To be able to satisfy the security requirements resulting from these risks of abuse, a concept will be required which combines active and passive security structures such as (photo)sensors and passivation layers. In this connection, an arrangement of light detectors for use in integrated circuits for chip cards is already known from, for example, U.S. Pat. No. 4,952,796 or from WO 98/22905 A1. While U.S. Pat. No. 4,952,796 describes a circuit with a bias element, comprising a diode as a light-sensitive detector component, WO 98/22905 A1 discloses a light detector with two field effect transistors having given properties.

Starting from the conventional arrangements, it is an object of the present invention to provide an electric or electronic circuit arrangement and a method of the type described in the opening paragraph, in which an optical attack by means of irradiation with electromagnetic waves, particularly by means of light, on a controller chip arrangement itself and on a dielectric layer covering the controller chip arrangement for protecting the integrated circuit from external influences, particularly an insulation layer and/or passivation layer and/or a further protective coating, can be reliably and permanently avoided, both on the front side of the controller chip arrangement and on the essentially unprotected rear side of the controller chip arrangement.

This object is solved by the characteristic features defined in claim 1 for an electric or electronic circuit arrangement for protecting at least a chip arrangement from manipulation and/or abuse, and by the characteristic features defined in claim 25 for a method of protecting at least a chip arrangement from manipulation and/or abuse. Advantageous further embodiments of the present invention are defined in the dependent claims.

The teaching of the present invention is based on covering the chip arrangement with at least a dielectric layer which is substantially opaque and cannot be easily removed, and on the additional protection of this dielectric layer by at least a detector unit (hereinafter referred to as “optosensitive detector unit”), by which, in addition to attacks on the dielectric layer, also attacks from the substantially unprotected rear side of the chip arrangement can be averted. This optosensitive detector unit therefore has the object in the security concept of the chip arrangement to avert or at least substantially complicate the afore-mentioned potential possibilities of attack.

The same physical principle as for the optosensitive detector unit itself is essentially based on the possibilities of attack: the irradiation with light, i.e. with photons of a suitable frequency or energy may generate electron hole pairs in semiconductor barrier layers and thus change the current through these layers. On the one hand, this may lead to failing functions of the chip arrangement to be protected and, on the other hand, it may trigger the optosensitive detector unit.

In this connection, the protection in the case of triggering the optosensitive detector unit consists of preventing access to the security-relevant data and/or functions, namely by partial or complete blocking of the data and/or functions of the chip arrangement, which blocking may be temporary, i.e. limited to the duration of the irradiation with light, or permanent. In the latter case, the chip arrangement concerned will then be permanently unusable. A further protective measure is to erase the security-relevant data and/or functions so that the chip arrangement concerned also becomes permanently unusable.

In order to withstand also an attack by partial removal of the substantially opaque dielectric coating, a plurality or many optosensitive detector units may be distributed on the chip arrangement in an efficient elaboration of the present invention.

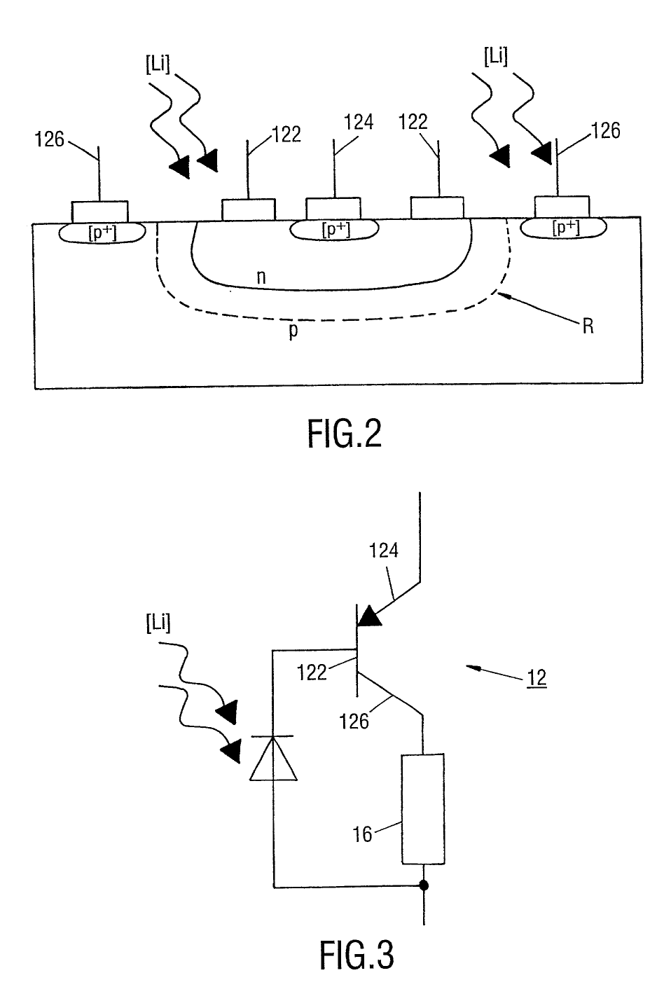

In accordance with a particularly inventive further embodiment, a particular aspect of the optosensitive detector unit may be the use of at least one bipolar transistor (FIG. 2) as a light-sensitive element, which transistor can be made available in a manufacturing process for normal digital circuits without using additional components, particularly no additional masks or diffusions.

In contrast to conventional phototransistors, these bipolar transistors can be advantageously arranged at a relatively large depth under the surface of the chip arrangement and thus relatively exactly at the height or the plane of the data and/or functions to be protected. Consequently, only light which penetrates as far as these bipolar transistors through the various superposed oxide layers can lead to a triggering action, which simplifies the test of the integrated circuits performed before the substantially opaque protective layer is provided on the wafer.

In accordance with a preferred embodiment of the present invention, the optosensitive detector unit comprises two units, in which the light detection is performed in a first unit. The output of the first unit in the rest state (i.e. no electromagnetic incidence of radiation) may have a relatively high electric potential (“high signal”). When light is incident on the optosensitive detector unit, the output voltage decreases in dependence upon the intensity and the wavelength of the incident light. Here the relation applies that the larger the wavelength, i.e. the smaller the frequency (for example, infrared electromagnetic radiation) upon irradiation of the optosensitive detector unit, the greater the probability that the photons can penetrate very deeply into the material of the optosensitive detector unit. Conversely, this means that for photons with a small wavelength, i.e. with a large frequency, there is a relatively great probability of absorbation in one of the outer layers.

The above-described decrease of the output voltage may be registered by means of at least one comparator unit which is accommodated in a second unit. When the value of the output voltage of the first unit falls below the value of a comparison or reference voltage, the comparator unit of at least a subsequent evaluation logic signalizes the state “light detected”. The light intensity at which the optosensitive detector unit switches may be adjusted by a suitable choice of the working point and/or the reference voltage.

In summary it can be concluded that the present invention provides an electric or electronic circuit arrangement as well as a method of protecting at least a chip arrangement from manipulation and/or abuse in which—as a delimitation of the arrangement disclosed in U.S. Pat. No. 4,952,796 or the arrangement disclosed in WO 98/22905 A1—an optical attack by means of irradiation with light on a chip arrangement itself as well as on a dielectric layer covering the chip arrangement and provided for protecting the integrated circuit from external influences, particularly an insulation layer and/or passivation layer and/or further protective coating, can be reliably and permanently averted, both on the front side of the chip arrangement and on its substantially unprotected rear side.

The present invention also relates to a card, particularly a chip card or smart card, comprising at least an electric or electronic circuit arrangement of the type described hereinbefore.

Finally, the present invention relates to a chip arrangement, for example, a (semiconductor) chip arrangement, particularly a controller chip arrangement for a chip card or a smart card, the arrangement comprising

at least one, preferably a plurality or a large number of particularly optosensitive detector units of the type described hereinbefore, and

at least one combination logic unit for combining the detector units.

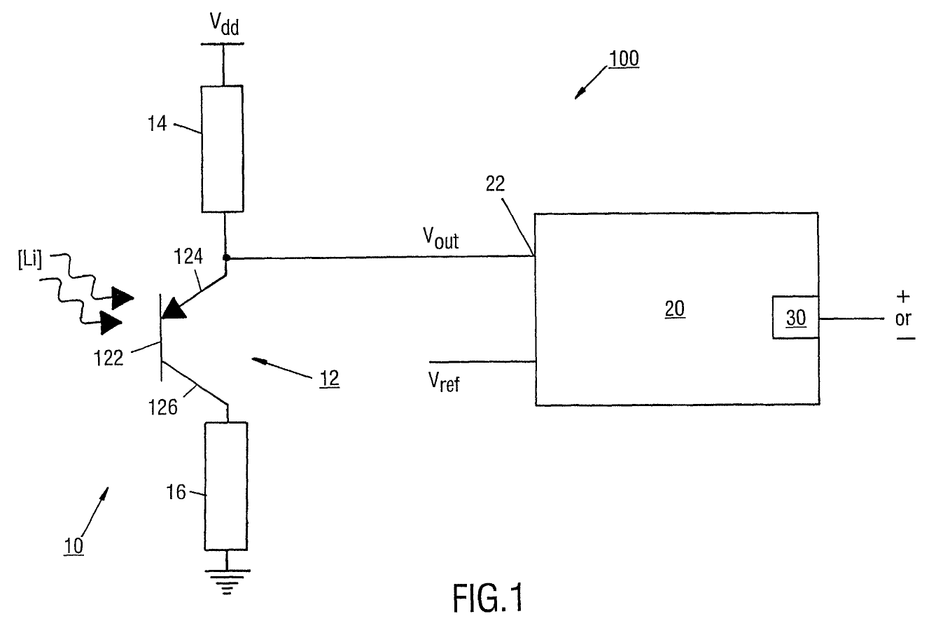

Further elaborations, characteristic features and advantages of the present invention will hereinafter be elucidated with reference to the embodiments shown in FIGS. 1 to 7.

FIG. 1 shows diagrammatically a circuit arrangement according to the present invention,

FIG. 2 shows the structure of a phototransistor in a cross-section,

FIG. 3 is an equivalent circuit diagram for delimiting a bipolar transistor from a photodiode;

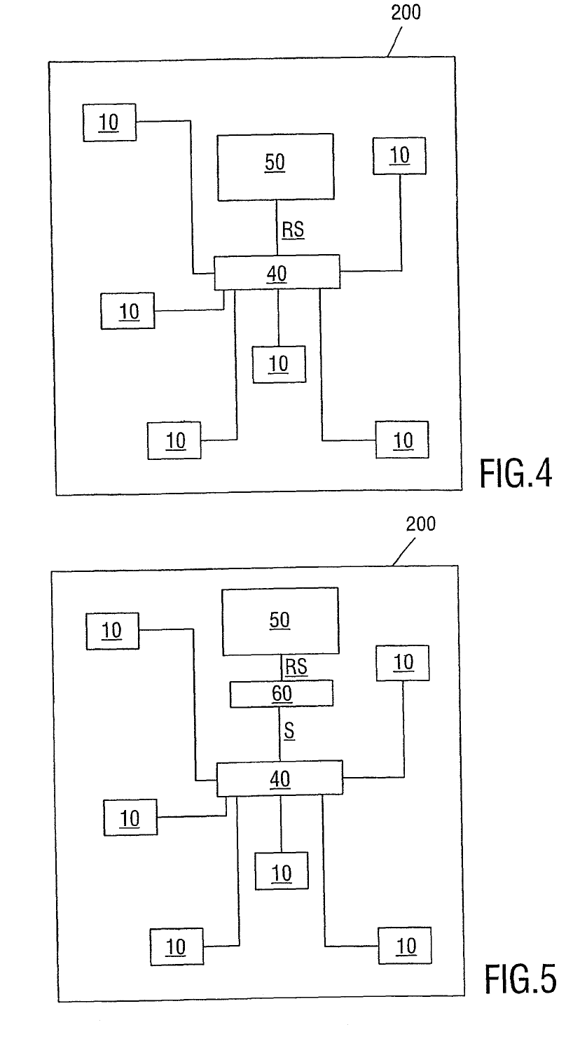

FIG. 4 shows a first possibility of using optosensitive detector units according to the present invention within the security concept of a smart card controller chip arrangement,

FIG. 5 shows a second possibility of using optosensitive detector units according to the present invention within the security concept of a smart card controller chip arrangement,

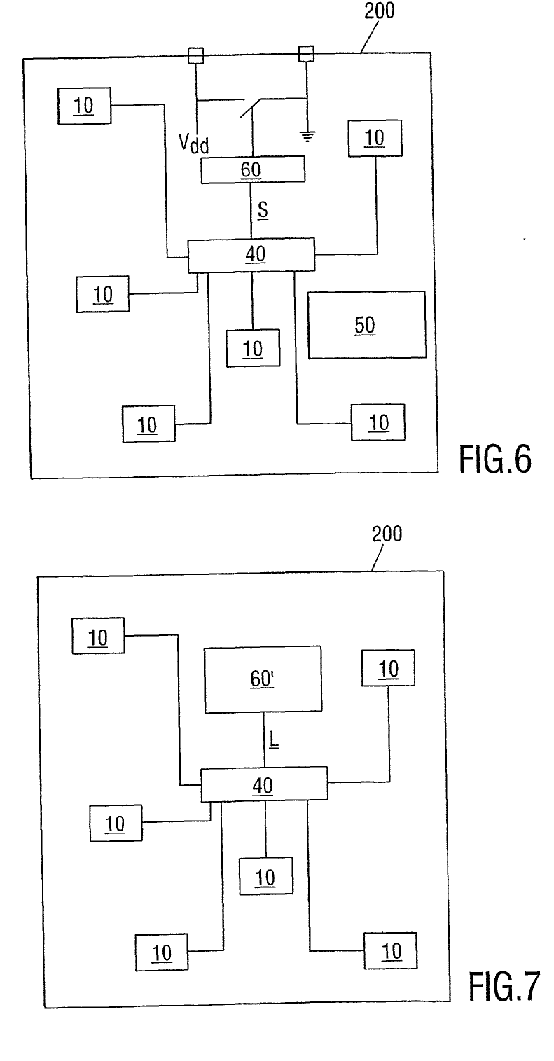

FIG. 6 shows a third possibility of using optosensitive detector units according to the present invention within the security concept of a smart card controller arrangement, and

FIG. 7 shows a fourth possibility of using optosensitive detector units according to the present invention within the security concept of a smart card controller chip arrangement.

Identical or similar elaborations, elements or characteristic features are denoted by identical reference signs in FIGS. 1 to 7.

The circuit arrangement 100 to be implemented and integrated in a chip card or smart card shown in FIG. 1 protects a silicon controller chip arrangement 200, shown in FIGS. 4 to 7, of the chip card or smart card from manipulation and/or abuse.

To be able to comply with the stringent security requirements in the field of the smart card chip technique, the concept of the embodiment according to the present invention is based on a combination of optosensitive detector units 10 and a dielectric protective coating which is provided to protect the chip arrangement 200 from external influences and cannot easily be removed, and which has the form of an opaque passivation layer. When the front side of the chip arrangement 200 is irradiated with electromagnetic waves, the security coating absorbs and/or reflects this light irradiation.

The irradiation of the chip arrangement 200 with light from the rear side is usually only possible when the chip arrangement 200 is released from its layered carrier substrate of insulating material. When such an irradiation of the chip arrangement 200 with light from the rear side takes place after the chip arrangement 200 has been stripped off its layered carrier substrate, then the optosensitive detector unit 10 registers this and issues a digital failure message. This failure message has the result that, for example, the access to the storage unit of the chip arrangement 200 or the whole chip arrangement 200 is blocked (a removal of the protective coating has substantially the same consequence).

The optosensitive detector unit 10 is therefore used for protection against unauthorized and/or unpermitted irradiation of the chip arrangement 200 with light of different wavelengths so as to generate charges which might change the mode of operation of the chip arrangement 200. More specifically, the optosensitive detector unit 10 is provided underneath the surface of the chip arrangement 200, namely substantially in the plane of the data and functions to be protected, in which the output voltage Vₒᵤₜ (cf. FIG. 1) of the detector unit 10 is a measure of the incidence of light on the detector unit 10. The detector unit 10 precedes a comparator unit 20 by means of which the output voltage Vₒᵤₜ of the detector unit 10 is compared with a reference voltage V_{ref} (cf. FIG. 1).

The data and/or functions of the chip arrangement 200 to be protected, are temporarily or permanently blocked and/or erased and/or interrupted upon a failure message occurring when the output voltage Vₒᵤₜ of the detector unit 10 is compared with the reference voltage V_{ref} upon a failure message occurring when the output voltage Vₒᵤₜ of the detector unit 10 is compared with the reference voltage V_{ref} (cf. the following elucidations of the four possibilities shown in FIGS. 4 to 7).

This optosensitive detector unit 10 comprises, as a main element, a field or array of spatially arranged bipolar transistors 12 in the form of pnp transistors (such a pnp transistor is shown by way of example in FIG. 1).

The optosensitive detector unit 10 utilizes the light-sensitive properties of semiconductor transistors, particularly of silicon transistors because the pnp transistor supplies an amplification of the photocurrent. As can be seen in FIG. 1, the emitter 124 of the bipolar transistor 12 is connected to the power supply voltage V_{dd} via a power supply resistor, whereas the collector 126 of the bipolar transistor 12 is connected to ground potential via a reference resistor 16.

The base of the bipolar transistor 12 is not connected. Since the incident light radiation (Li) is substantially incident on the junction between the base 122 of the bipolar transistor 12 and the collector 126 of the bipolar transistor 12, and generates electron hole pairs both in the area of the base 122 and in the adjacent area of the collector 126, the reverse-biased junction between the base 122 and the collector 126 extracts holes but also presses electrons into the base 122. Consequently, the base 122 becomes more negative with respect to the emitter 124, and the junction between the base 122 and the emitter 124 is more strongly driven in the forward direction. The emitter current and hence the collector current are increased, with the phototransistor being only of a limited rate due to minority carrier effects in the base 122.

Since the collector junction in the phototransistor in principle operates like a photodiode, the bipolar transistor 12 can be separated from the photodiode for the purpose of forming a model, which is illustrated in the equivalent circuit diagram in FIG. 3. The emitter 124 of the bipolar transistor 12 is connected to the input 22 of the comparator unit 20, which input 22 is provided for the output voltage Vₒᵤₜ, so that the output voltage Vₒᵤₜ of the detector unit 10 decreases with an increasing wavelength and/or with an increasing intensity of the incident light. More specifically, an evaluation unit 13 preceded by the comparator unit 20 generates the failure message when the value of the output voltage Vₒᵤₜ of the detector unit 10 falls below the value of the reference voltage V_{ref}. The working point of the detector unit 10 and the value of the reference voltage V_{ref} are adjustable in this case, so that the use of the comparator unit 20 provides overall degrees of freedom of adjusting the switching threshold.

As is clear from the elucidations described hereinbefore, the generation of electron hole pairs plays a substantial role within the scope of the present invention. As far as the silicon used as a semiconductor material for the phototransistors is concerned, the spectral sensitivity in the embodiment according to the present invention has a relatively wide wavelength range from about 450 nm to about 1050 μm, the maximum being at a wavelength of about 800 nm.

FIGS. 4 to 7 show four possibilities of using optosensitive detector units 10 according to the present invention within the security concept of a smart card controller chip arrangement 200. These four possibilities have six detector units 10 which are distributed by way of example and protect the smart card controller chip arrangement 200 from light-induced attacks, both on the front side and on the rear side in a reliable and permanent manner (cf. also FIG. 1) and comprise a combination logic unit 40 by which the six detector units 10 are combined with each other and which control and co-ordinate the co-operation between the six detector units 10.

In accordance with the first embodiment shown by way of example in FIG. 4, a control logic unit 50 connected to the combination logic unit 40 is now blocked temporarily—by way of a “reset” RS—when the front side and/or the rear side of the smart card controller chip arrangement 200 is irradiated. In other words, this means that the attack on the security-relevant data and/or functions is blocked at least as long as the smart card controller chip arrangement 200 is electromagnetically irradiated.

In accordance with the second embodiment shown by way of example in FIG. 5, the control logic 50 is blocked (RS) permanently, which is triggered by a blocking (S) of a once-electrically programmable storage unit 60 arranged between the combination logic 40 and the control logic 50, when the front side and/or the rear side of the smart card controller chip arrangement 200 is irradiated. To this end, the storage unit 60 triggers a permanent blocking of the control logic 50 by means of a “reset” (RS). In other words, this means that the access to the security-relevant data and/or functions is still blocked when the smart card controller chip arrangement 200 is no longer electromagnetically irradiated.

In accordance with the third embodiment shown by way of example in FIG. 6, the overall smart card controller chip arrangement 200 is permanently blocked by means of a short-circuit of the power supply voltage V_{dd} which is triggered by the permanent blocking (S) of a once-electrically programmable storage unit 60 connected to the combination logic 40, when it is attempted for manipulative and abusive purposes to find security-relevant data and/or functions by way of light irradiation of the front side and/or the rear side of the smart card controller chip arrangement 200. To this end, the storage unit 60 triggers a permanent short-circuit of the power supply voltage V_{dd}. In other words, this means that the access to the security-relevant data and/or functions is still blocked when the smart card controller chip arrangement 200 is no longer subjected to an electromagnetic radiation because the power supply terminals of the smart card controller chip arrangement 200 concerned are short-circuited permanently.

In accordance with the fourth embodiment shown by way of example in FIG. 7, the security-relevant data and/or functions are finally erased (L) in an EEPROM storage unit 60′ (EEPROM=Electrically Erasable Programmable Read-Only Memory) connected to the combination logic unit 40 when it is attempted for manipulative and abusive purposes to find security-relevant data and/or functions by way of light irradiation of the front side and/or the rear side of the smart card controller chip arrangement 200. In this fourth possibility, the smart card controller chip arrangement 200 concerned becomes permanently unusable because the security-relevant data and/or functions are erased.

List of reference signs

| | |
|---|---|
| 100 | electric or electronic circuit arrangement |
| 10 | detector unit |
| 12 | bipolar transistor, particularly pnp transistor |
| 122 | base of the bipolar transistor 12 |
| 124 | emitter of the bipolar transistor 12 |
| 126 | collector of the bipolar transistor 12 |
| 14 | power supply resistor |
| 16 | reference resistor |
| 20 | comparator unit |
| 22 | input of the comparator unit 20 |
| 30 | evaluation unit |
| 40 | combination logic unit |
| 50 | control logic unit |
| 60 | storage unit, particularly an electrically erasable storage unit |
| 60′ | EEPROM storage unit |
| 200 | chip arrangement, for example (semiconductor) chip |
| | arrangement, particularly controller chip arrangement for chip |
| | card or smart card |
| L | erasing |
| Li | light |
| R | space charge zone |
| RS | reset |
| S | blocking |
| SiNO₂ | silicon nitrite |
| SiO₂ | silicon dioxide |
| Vₒᵤₜ | output voltage |
| V_{dd} | power supply voltage |
| V_{ref} | reference voltage |

1. An electric or electronic circuit arrangement (100) for protecting at least a chip arrangement (200), for example, at least a (semiconductor) chip arrangement, particularly at least a controller chip arrangement for a chip card or smart card, from manipulation and/or abuse, characterized by
at least one, particularly optosensitive detector unit (10), whose output voltage (Vₒᵤₜ) is a measure of the incidence of light (Li) on the detector unit (10), and
at least one comparator unit (20) preceded by the detector unit (10) provided for comparing the output voltage (Vₒᵤₜ) of the detector unit (10) with a reference voltage (V_{ref}), wherein the data and/or functions of the chip arrangement (200) to be protected can be temporarily or permanently obstructed and/or erased (L) and/or blocked (S) and/or interrupted in the case of a failure message occurring during comparison of the output voltage (Vₒᵤₜ) of the detector unit (10) with the reference voltage (V_{ref}).

2. A circuit arrangement (100) as claimed in claim 1, characterized in that the detector unit (10) is arranged
underneath the surface of the chip arrangement (200), particularly underneath at least an oxide layer of the chip arrangement (200), and/or
substantially in the plane of the data and/or functions to be protected.

3. A circuit arrangement (100) as claimed in claim 1 or 2, characterized in that the detector unit (10) comprises at least one bipolar transistor (12), particularly at least one pnp transistor.

4. A circuit arrangement (100) as claimed in claim 3, characterized in that the detector unit (10) is constituted by a plurality or a large number of spatially arranged bipolar transistors (12).

5. A circuit arrangement (100) as claimed in any one of claims 3 to 4, characterized in that the emitter (124) of the bipolar transistor (12) is connected to the input (22), provided for the output voltage (Vₒᵤₜ), of the comparator unit (20).

6. A circuit arrangement (100) as claimed in any one of claims 3 to 5, characterized in that the emitter (124) of the bipolar transistor (12) is connected to at least a power supply voltage (V_{dd}) via at least a power supply resistor (14).

7. A circuit arrangement (100) as claimed in any one of claims 3 to 6, characterized in that the collector (126) of the bipolar transistor (12) is connected to ground potential via at least a reference resistor (16).

8. A circuit arrangement (100) as claimed in any one of claims 3 to 7, characterized in that the junction between the base (122) of the bipolar transistor (12) and the collector (126) of the bipolar transistor (12) is provided for absorbing the light incident on the detector unit (10).

9. A circuit arrangement (100) as claimed in any one of claims 1 to 8, characterized in that the output voltage (Vₒᵤₜ) of the detector unit (10) depends on the wavelength and/or the intensity of the incident light (Li).

10. A circuit arrangement (100) as claimed in any one of claims 1 to 9, characterized in that
at least an evaluation unit (30) is implemented and/or integrated in the comparator unit (20), or
the comparator unit (20) precedes at least an evaluation unit (30).

11. A circuit arrangement (100) as claimed in claim 10, characterized in that the evaluation unit (30) generates the failure message when the output voltage (Vₒᵤₜ) of the detector unit (10) deviates from the nominal range.

12. A circuit arrangement (100) as claimed in any one of claims 1 to 11, characterized in that
the working point of the detector unit (10) and/or
the threshold value of the reference voltage (V_{ref}) is adjustable.

13. A circuit arrangement (100) as claimed in any one of claims 1 to 12, characterized in that at least a dielectric coating, particularly an insulation layer and/or passivation layer and/or a further protective coating which is provided for protecting the chip arrangement (200) from external influences and preferably cannot be easily removed is arranged within the chip arrangement (200) and/or laterally to the chip arrangement (200) and/or on the chip arrangement (200).

14. A circuit arrangement (100) as claimed in claim 13, characterized in that the material of the dielectric coating is epoxy resin or silicon nitrite (SiNO₂) or silicon dioxide (SiO₂), or other insulating materials used in the manufacture of semiconductors.

15. A circuit arrangement (100) as claimed in claim 13 or 14, characterized in that the material of the dielectric coating is substantially opaque.

16. A circuit arrangement (100) as claimed in any one of claims 1 to 15, characterized in that the chip arrangement (200) is arranged on at least a particularly layered carrier substrate of a semiconducting or insulating material.

17. A circuit arrangement (100) as claimed in any one of claims 1 to 16, characterized in that the circuit arrangement (100) is implemented and/or integrated in at least a card, particularly in at least a chip card or in at least a smart card.

18. A card, particularly a chip card or smart card, comprising at least an electric or electronic circuit arrangement (100) as claimed in any one of claims 1 to 17.

19. A chip arrangement (200), for example a (semiconductor) chip arrangement, particularly a controller chip arrangement for a chip card or smart card, the chip arrangement comprising
at least one, preferably a plurality or a large number of particularly optosensitive detector units (10) as claimed in any one of claims 1 to 20, and
at least a combination logic unit (40) for combining the detector units (10).

20. A chip arrangement (200) as claimed in claim 19, characterized in that the combination logic unit (40) is connected to at least a control logic unit (50).

21. A chip arrangement (200) as claimed in claim 19 or 20, characterized in that the combination logic unit (40) is connected to at least a particularly electrically erasable storage unit (60).

22. A chip arrangement (200) as claimed in claim 21, characterized in that the storage unit (60) is constituted by at least an EEPROM storage unit (60′) (EEPROM=Electrically Erasable Programmable Read-Only Memory), and the data and/or functions of the chip arrangement (200) to be protected are erasable (L) when a failure message by means of the EEPROM storage unit (60′) occurs particularly during comparison of the output voltage (Vₒᵤₜ) of the detector unit (10) with the reference voltage (V_{ref}).

23. A chip arrangement (200) as claimed in claim 20, 21 or 22, characterized in that
the storage unit (60) is arranged between the combination logic unit (40) and the control logic unit (50), and
the access to the data and/or functions of the chip arrangement (200) to be protected can be blocked by blocking (S) the storage unit (60) when a failure message occurs particularly during comparison of the output voltage (Vₒᵤₜ) of the detector unit (10) with the reference voltage (V_{ref}).

24. A chip arrangement (200) as claimed in any one of claims 19 to 23, characterized in that the chip arrangement (200) can be permanently short-circuited via the power supply voltage (V_{dd}), particularly via the power supply terminals of the chip arrangement (200).

25. A method of protecting at least a chip arrangement (200), for example at least a (semiconductor) chip arrangement, particularly at least a controller chip arrangement for a chip card or smart card from manipulation and/or abuse, characterized in that
an output voltage (Vₒᵤₜ) determined by light (Li) incident on the detector unit (10) is generated in at least a particularly optosensitive detector unit (10), particularly in at least a bipolar transistor (12);
the output voltage (Vₒᵤₜ) of the detector unit (10) is compared with a reference voltage (V_{ref}) in at least a comparator unit (20) preceded by the detector unit (10), and
the data and/or functions of the chip arrangement (200) to be protected are temporarily or permanently obstructed and/or erased (L) and/or blocked (S) and/or interrupted when a failure message is generated during comparison of the output voltage (Vₒᵤₜ) of the detector unit (10) with the reference voltage (V_{ref}).

26. A method as claimed in claim 25, characterized in that the light incident on the detector unit (10) is substantially absorbed by means of the junction between the base (122) of the bipolar transistor (12) and the collector (126) of the bipolar transistor (12).

27. A method as claimed in claim 25 or 26, characterized in that the failure message is triggered in the comparator unit (20) when the output voltage (Vₒᵤₜ) of the detector unit (10) deviates from the nominal range.

28. A method as claimed in any one of claims 25 to 27, characterized in that the triggering of the failure message is adjusted by means of
the working point of the detector unit (10) and/or
the threshold value of the reference voltage (V_{ref}).

29. A method as claimed in any one of claims 25 to 28, characterized in that the failure message is generated in at least
an evaluation unit (30) implemented and/or integrated in the comparator unit (20), or
an evaluation unit (30) preceded by the comparator unit (20).

30. A method as claimed in any one of claims 25 to 29, characterized in that at least a control logic unit (50) connected to at least a combination logic unit (40) provided for combining the detector units (10) is temporarily blocked (S) when the failure message is triggered.

31. A method as claimed in any one of claims 25 to 29, characterized in that at least an electrically erasable storage unit (60) arranged between at least a combination logic unit (40) provided for combining the detector units (10) and at least a control logic unit (50) is permanently blocked (S) when the failure message is triggered.

32. A method as claimed in claim 31, characterized in that the control logic unit (50) is temporarily or permanently blocked (S) by means of at least a “reset” (RS).

33. A method as claimed in any one of claims 25 to 29, characterized in that a particularly once-electrically programmable storage unit (60) connected to at least a combination logic unit (40) provided for combining the detector units (10) is permanently blocked (S) when the failure message is triggered.

34. A method as claimed in claim 33, characterized in that the power supply voltage (V_{dd}) is short-circuited by means of the storage unit (60), and particularly the power supply terminals of the chip arrangement (200) are short-circuited.

35. A method as claimed in any one of claims 25 to 29, characterized in that the data and/or functions to be protected are erased (L) in an EEPROM storage unit (60′) (EEPROM=Electrically Erasable Programmable Read-Only Memory) connected to at least a combination logic unit (40) provided for combining the detector units (10) when the failure message is triggered.
